(19) United States
(12) Patent Application Publication
(10) Pub. No.: US 2007/0029346 A1
(43) Pub. Date: Feb. 8, 2007

(54) Pneumatic greaser

(76) Inventor: Fu-Tian Hung, Tai Ping City (TW)

Correspondence Address: Rabin & Berdo, P.C., Suite 500, 1101 14th Street, Washington, DC, 20005, US

(21) Appl. No.: 11/195,807

(22) Filed: Aug. 3, 2005

(51) Int. Cl. G01F 11/00

(52) U.S. Cl. 222/261

(57) ABSTRACT

A pneumatic greaser has a body and a barrel. A piston is movably received in the body and defined with a valve hole at a rear end thereof. A pole is formed on the pole plate positioned in the piston. Multiple linkages extend through the pole plate and are connected with an exterior sheet and an interior sheet. A valve spring is provided between the exterior sheet and the pole plate. A valve shaft extends through the valve hole. A rear cushion is mounted on a rear end of the valve shaft. A front cushion is mounted outside the exterior sheet. A buffer spring is provided between the front cushion and the barrel. Whereby, during the reciprocation of the piston, the valve hole can be reliably closed by the rear cushion under the force of the valve spring. Thus, the pneumatic greaser can during operation stably and continuously eject grease with a low impact.

### BACKGROUND OF THE INVENTION

1. Field of the Invention

The present invention relates to a pneumatic greaser, and more particularly to a pneumatic greaser which can stably and selectively eject a continuous supply of grease.

2. Description of Related Art

A conventional pneumatic greaser has an air chamber defined between a body and a barrel. A piston and a resilient member are provided in the air chamber. The piston is pushed towards the barrel by pressured air. An ejecting means is provided in the piston for continuously ejecting a consistent supply of grease.

The ejecting means has a rear plate to open/close an air hole. When the air hole is closed, the piston is pushed forwards by the pressured air to eject the consistent grease. While the piston is moved forwards, the ejecting means is moved backwards relative to the piston and the air hole is opened. Thus, the pressured air flows out to enable the resilient member to push the piston back to the original position. Thus, due to continuous supply of air, the piston is automatically reciprocated to continuously eject grease.

However, the air hole is closed when the rear plate abuts a rear wall of the air chamber and it is unreliable to close the air hole by this means. When the air hole is not completely closed, the piston can not be pushed by the pressured air. Moreover, the pneumatic greaser is not provided with any cushion means, so the reciprocation of the piston will cause vibration and shock which makes the ejection of grease unstable.

Therefore, the invention provides a pneumatic greaser to mitigate or obviate the aforementioned problems.

### SUMMARY OF THE INVENTION

The main objective of the present invention is to provide pneumatic greaser which can stably and selectively eject a continuous supply of grease.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a pneumatic greaser in accordance with the present invention;

FIG. 2 is a cross sectional view of the pneumatic greaser in FIG. 1;

FIG. 3 is a cross sectional view of the pneumatic greaser in a status of a piston being pushed forwards by pressured air; and

FIG. 4 is a cross sectional view of the pneumatic greaser in a status of the pressured air being discharged out from an air vent.

### DETAILED DESCRIPTION OF THE PREFERRED EMBODIMENT

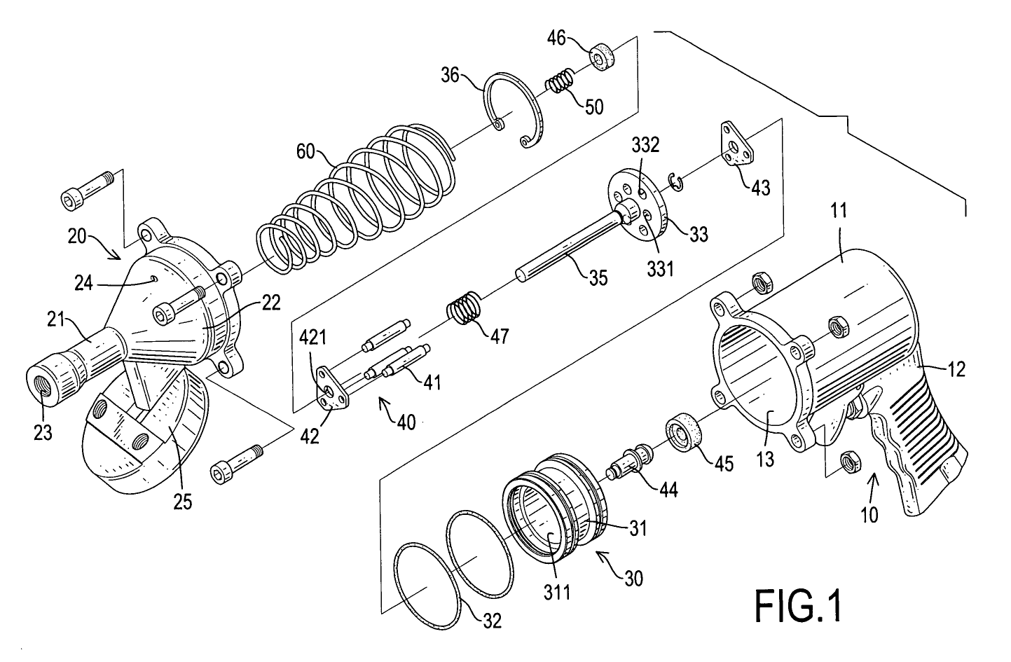

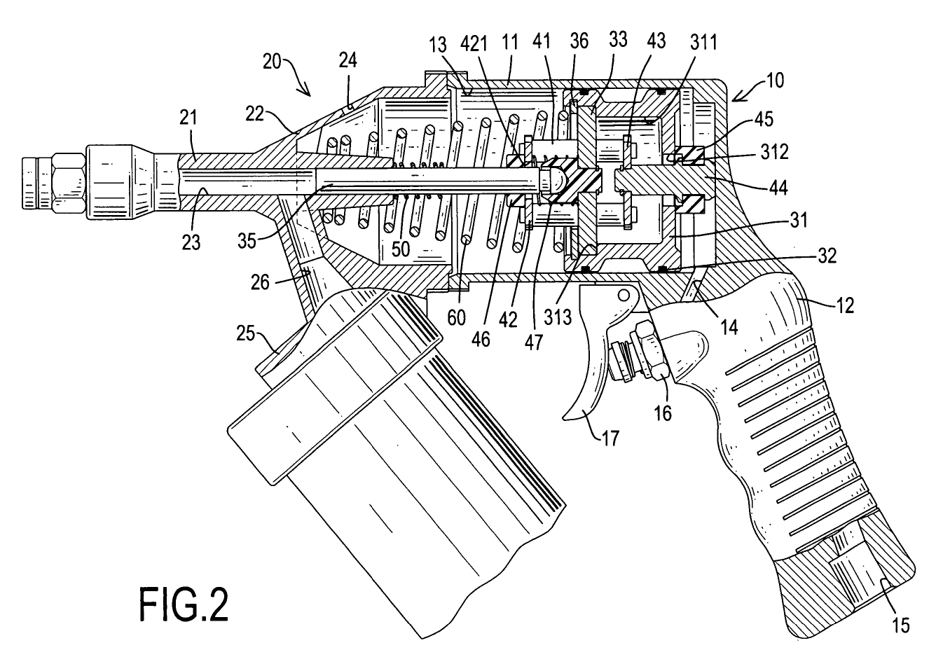

With reference to FIGS. 1-2, a pneumatic greaser for stable and selective ejection of a continuous supply of grease in accordance with the present invention is generally composed of a body (10), a barrel assembly (20), a booster (30), a reciprocating member (40), a buffer resilient member (50), and a piston resilient member (60).

The body (10) has a tube (11) with a closed end and an open end. A grip (12) is integrally formed at the closed end of the tube (11). A recess (13) is defined in the tube (11), and an air channel (14) is defined in the grip (12) and in communication with the recess (13). An air inlet (15) is defined at a bottom of the grip (12) for being connected to a pressured air supply. An air valve (16) is provided at a front side of the grip (12) to open/close the air channel (14), and a trigger (17) is pivotally mounted on an outer periphery of the tube (11) for operating the air valve (16).

The barrel assembly (20) has a front barrel (21) and a rear barrel (22). The rear barrel (22) is formed with a tapered shape and mounted on the tube (11). The front barrel (21) is formed at a center of the rear barrel (22), and has a rear end extending into the rear barrel (22) and a passage (23) defined therethrough. An air vent (24) is defined through the rear barrel (22). A connecting plate (25) is formed at a bottom of the rear barrel (22) and has a grease channel (26) defined therein and in communication with the passage (23).

The booster (30) has a piston (31) movably received in the tube (11). Two O-rings (32) are respectively provided at a front end and a rear end of the piston (31). A hole (311) is defined in a front end of the piston (31) and a valve hole (312) is defined in a rear end of the piston (31) and communicated with the hole (311). A shoulder (313) is formed in the hole (311), and a pole plate (33) abuts the shoulder (313) and is positioned in the hole (311) by a C-like collar (36). A pole (35) is formed at a center of the pole plate (33) and extends in the passage (23) of the front barrel (21). Three linkage holes (331) and three air holes (332) are alternately defined around the pole (35). The quantities of the linkage holes (331) and air holes (332) can be various and will not be limited to three.

The reciprocating member (40) has three linkages (41) respectively extending through the linkage holes (331). An exterior sheet (42) is mounted on front ends of the linkages (41), and an interior sheet (43) is mounted on rear ends of the linkages (41) and located in the hole (311) of the piston (31). A pole hole (421) is defined through the center of the exterior sheet (42) for the pole (35) extending therethrough. A valve spring (47) is mounted over the pole (35) and between the exterior sheet (42) and the pole plate (33). A front cushion (46) is mounted on an outer side of the exterior sheet (42). A valve shaft (44) extends through the valve hole (312) of the piston (31), wherein a front end of the valve shaft (44) is mounted on the interior sheet (43), and a rear end of the valve shaft (44) is mounted with a rear cushion (45).

The buffer resilient member (50) is provided on the pole (35), and has a first end abutting the rear end of the front barrel (21), and a free second end. A length of the buffer resilient member (50) is substantially equal to a distance from the rear end of the front barrel (21) to a rear end of the rear barrel (22).

The piston resilient member (60) has a front end provided outside the rear end of the front barrel (21), and a rear end provided outside the linkages (41). Thus, the pole (35), exterior sheet (42) and the linkages (41) are received in the piston resilient member (60).

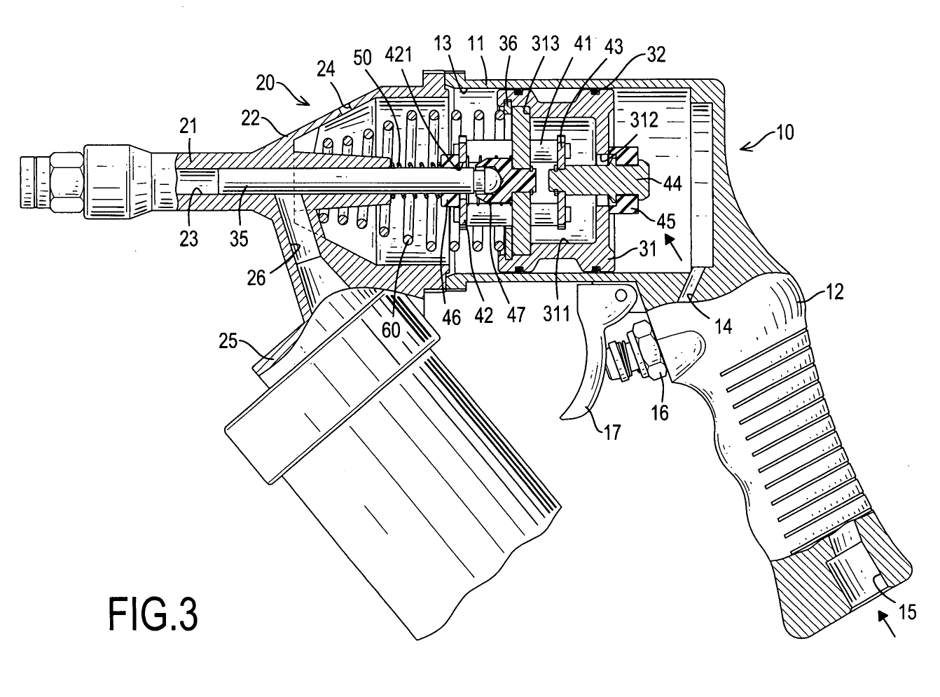

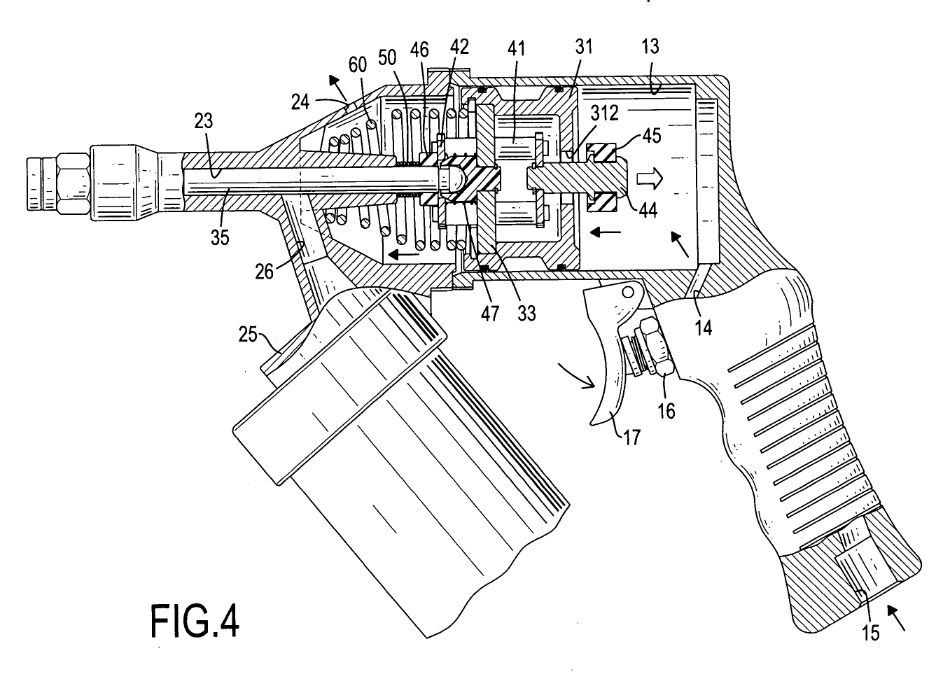

In operation, with reference to FIGS. 1, 3, and 4, a grease container is mounted under the connecting plate (25) for supplying grease. An air supply is connected to the grip (12) through the air inlet (15). When the trigger (17) is pressed to release the air valve (16), pressured air flows into the recess (13) through the air channel (14). In this case, under the force of the valve spring (47), the exterior sheet (42) is pushed forwards and the valve hole (312) is closed by the rear cushion (45). Then, the piston (31) will be pushed forwards by the pressured air flowing into the recess (13), and grease in the passage (23) is ejected by the pole (35) out from the front barrel (21).

During the forward movement of the piston (31), the piston resilient member (60) is compressed by the pole plate (33). When the front cushion (46) is in contact with the buffer resilient member (50), the movement of the exterior sheet (42) will be slowed down to reduce a distance between the exterior sheet (42) and the pole plate (33). In other words, the reciprocating member (40) is moved backwards relative to the pole plate (33) and the piston (31). Then, the valve shaft (44) is also moved backwards relative to the piston (31) to open the valve hole (312). In this case, pressured air will flow through the valve hole (312), the air holes (332) and out from the air vent (24). Therefore, the piston (31) is pushed back to the original position under the force of the piston resilient member (60) while grease is pumped into the passage (23) for the next ejection due to the pole (35) being retracted from the passage (23).

When the front cushion (46) separates from the buffer resilient member (50), the exterior sheet (42) can be pushed by the compressed valve spring (47) to move forwards relative to the pole plate (33). When the valve shaft (44) is stopped at the closed end of the tube (11), the valve hole (312) is closed again by the rear cushion (45), so the piston (31) can be pushed forwards by the pressured air again. Because the pressured air is continuously supplied, the piston (31) is automatically reciprocated in the tube (11) to continuously eject grease from the front barrel (21).

According to the present invention, by using the buffer resilient member (50), the valve hole (312) can be surely opened and the movement of the piston (31) is smooth and stable. The front cushion (46) mounted on the exterior sheet (42) can provide a cushion effect for the piston (31), so the piston (31) is moved further stably. The rear cushion (45) is pushed by the valve spring (47) to surely close the valve hole (47). Therefore, the pneumatic greaser can stably and continuously eject grease with a low impact during operation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pneumatic greaser comprising:
a body (10) having a tube (11) with a closed end and an open end, a grip (12) integrally formed at the closed end of the tube (11), a recess (13) defined in the tube (11), and an air inlet (15) defined at a bottom of the grip (12) for being connected to a pressured air supply;
a barrel (20) having a rear barrel (22) mounted on the open end of the tube (11), a front barrel (21) mounted at a center of the rear barrel (22) and with a rear end extending into the rear barrel (22), a passage (23) defined through the front barrel (21), an air vent (24) defined through the rear barrel (22), a connecting plate (25) formed at a bottom of the rear barrel (22), and a grease channel (26) defined in the connecting plate (25) and in communication with the passage (23);
a booster (30) having a piston (31) movably received in the recess (13), a hole (311) defined in a front end of the piston (31), a valve hole (312) defined in a rear end of the piston (31) and communicated with the hole (311), a pole plate (33) positioned in the hole (311); a pole (35) formed at a center of the pole plate (33) and extending in the passage (23), multiple linkage holes (331) and at least one air hole (332) defined around the pole (35) in the pole plate (33);
a reciprocating member (40) having multiple linkages (41) respectively extending through the linkage holes (331), an exterior sheet (42) mounted on front ends of the linkages (41), an interior sheet (43) mounted on rear ends of the linkages (41) and located in the hole (311) of the piston (31), a valve spring (47) provided outside the pole (35) and between the exterior sheet (42) and the pole plate (33), a valve shaft (44) extended through the valve hole (312) of the piston (31), wherein a front end of the valve shaft (44) is mounted on the interior sheet (43), and a rear end of the valve shaft (44) is mounted with a rear cushion (45);
a buffer resilient member (50) provided on the pole (35), and having a front end abutting the rear end of the front barrel (21); and
a piston resilient member (60) having a front end provided outside the rear end of the front barrel (21), and a rear end provided outside the linkages (41) for receiving the pole (35), the exterior sheet (42) and the linkages (41) in the piston resilient member (60).

2. The pneumatic greaser as claimed in claim 1, wherein the pole plate (33) has three linkage holes (331), and three linkages (41) respectively extend through the linkage holes (331).

3. The pneumatic greaser as claimed in claim 1, wherein the booster (30) has two O-rings (32) respectively provided at a front and rear ends of the piston (31).

4. The pneumatic greaser as claimed in claim 1, wherein the booster (30) has a shoulder (313) formed in the hole (311), and the pole plate (33) abuts the shoulder (313) and is positioned in the hole (311) by a C-like collar (36).

5. The pneumatic greaser as claimed in claim 1, wherein a front cushion (46) is mounted on an outer side of the exterior sheet (42), and the pole (35) extends through the front cushion (46).
